(19) United States
(12) Patent Application Publication
(10) Pub. No.: US 2004/0257540 A1
(43) Pub. Date: Dec. 23, 2004

(54) Single or multi-projector for arbitrary surfaces without calibration nor reconstruction

(76) Inventors: Sebastien Roy, Montreal (CA); Jean-Philippe Tardif, Longueuil (CA)

Correspondence Address: BROUILLETTE KOSIE PRINCE, 25th Floor, 1100 Rene-Levesque Blvd. West, Montreal, H3B 5C9, CA

(21) Appl. No.: 10/825,113

(22) Filed: Apr. 16, 2004

Related U.S. Application Data
(60) Provisional application No. 60/463,056, filed on Apr. 16, 2003.

(51) Int. Cl. G03B 21/14

(52) U.S. Cl. 353/69

(57) ABSTRACT

In the method and system for displaying an undistorted, target image on a surface of unknown geometry, an image of the surface is captured from the point of view of an observer, a mapping is established between pixels of the captured image and pixels of the target image, taking into consideration respective positions of the observer and surface, and the target image is displayed on the surface. The display of the target image comprises a correction of the target image in relation to the established mapping to display on the surface a target image undistorted from the point of view of the observer.

### FIELD OF THE INVENTION

The present invention relates to a new approach for displaying an undistorted image on a surface of unknown geometry.

### BACKGROUND OF THE INVENTION

Recently, augmented reality has been undergoing a very significant growth. It is believed that three-dimensional (3D) video-conferencing, real-time annotation and simulation will be widely used in the near future [1]. Coupled with increasing computing power, the improvement of electronic frame grabbers and projectors adds even more possibilities. For instance, a virtual world could be displayed through projectors on the walls of a room to give someone a sense of immersion. Also, projection of an X-ray image over a patient's body could help a physician to get more accurate information about the location of a tumour, or simple information about the patient's condition could be displayed in the physician's visual field. In many instances, many projectors have to be used to cover the whole environment or to prevent occlusions from people or objects. In addition, the projected images have to take into account the observer's position inside the room, and the projection surface geometry as illustrated in FIG. 1. Still, immersing experiences are difficult to implement because image projection in various environments is hard to achieve. This is due to the wide range of screen geometry.

The projection problem can be divided into three main sub-problems. First, the image has to be corrected with respect to the screen geometry and the position of the observer. Second, multiple projector calibration and synchronization must be achieved to cover the field of vision of the observer. This includes colour correction, intensity blending and occlusion detection. Last of all, illumination effects from the environment have to be considered and corrected if possible.

Many articles propose methods for solving parts of this problem in different contexts. Systems for projecting over non-flat surfaces already exist. It has been demonstrated that once the projectors are calibrated, texture can be painted over objects whose geometry is known [2]. This result has been confirmed with non-photorealistic 3D animations projected over objects [3]. Unfortunately, getting projector parameters is not always simple. For example, hemispherical lenses cannot be described with typical matrix formulation. Also, some applications need very fast surface reconstruction that remains today very challenging. Among reconstruction methods are structured light techniques, which can be used to scan small objects [4], [5] while stereo based systems with landmark projection over the surface offer a simple way to get the 3D geometry of the surface with triangulation. Of course, camera calibration is a prerequisite in each case [6].

When assumptions are made, simpler approaches can be used to correct the images. When the screen is assumed flat, keystoning rectification allows the projector and the observer to be placed at an angle relative to the surface [7, 8]. In this case, a camera and a tilt sensor mounted on the projector, or a device tracking the person is needed. Real-time correction is possible with video card hardware acceleration.

Multi-projector systems are of two types. The first is a large array of projectors which require calibration and synchronization [9, 10]. As many as 24 projectors can be used together to cover very large screens with high resolution. In all cases, affine matrices are obtained for each projector during a calibration process with cameras. Intensity blending is later used to get uniform illumination over the surface. Effective methods to synchronize a large number of projectors are also presented by the authors. The second type of system does the same in the more general context of augmented reality where the surfaces are not necessarily flat. The process stays essentially the same except that surface reconstruction is needed. Intensity blending can then be used [6].

Real-time algorithms for correcting shades produced by a person or an object placed in front of a projector exist in the literature [11, 12]. The authors rely on other projectors to fix the image on the screen.

Finally, some researchers were interested in the problem of colour calibration of multi-projectors [13]. They present a way of correcting the images according to the photometric characteristics of the projectors.

### SUMMARY OF THE INVENTION

The present invention relates to a method of allowing at least one projector to display an undistorted, target image on a surface of unknown geometry, comprising: capturing, by means of a camera, an image of the surface from the point of view of an observer; establishing a mapping between pixels of the image from the camera and pixels of a projector image; projecting the target image on the surface using the projector, the projection of the target image comprising correcting the target image in relation to the established mapping to display on the surface a target image undistorted from the point of view of the observer.

The present invention further relates to a system for allowing at least one projector to display an undistorted, target image on a surface of unknown geometry, comprising: a camera for capturing an image of the surface from the point of view of an observer; a producer of a mapping between pixels of the camera image and pixels of a projector image; the at least one projector for projecting the target image on the surface using the projector, the system comprising a corrector of the target image projected by the at least one projector in relation to the established mapping to display on the surface a target image undistorted from the point of view of the observer.

The foregoing and other objects, advantages and features of the present invention will become more apparent upon reading of the following non restrictive description of an illustrative embodiment thereof, given by way of example only with reference to the accompanying drawings.

### BRIEF DESCRIPTION OF THE DRAWINGS

In the appended drawings:

FIG. 1 is a top plan view of a setup including a screen, a camera and a projector and showing the respective positions of these screen, camera and projector with respect to each other;

FIG. 2 is a flow chart showing a series of operations conducted by the illustrative embodiment of the method according to the present invention, during an image construction process corrected for a specific projector-observer-screen configuration;

FIG. 3a is an example of projection patterns for bits b=4, 3, 2, 1, used to obtain a function R_{b}^{s};

FIG. 3b is an example of projection patterns for bits b=4, 3, 2, 1, used to obtain a function R_{b}^{t};

FIG. 4a is an example of histogram of Δ values representative of pixel-by-pixel differences between an image and its inverse, showing that large stripes yield very good separation;

FIG. 4b is an example of histogram of Δ values representative of pixel-by-pixel differences between an image and its inverse, showing that small stripes are hard to differentiate;

FIG. 5 is a graph of the percentage of usable pixels recovered from different stripe widths, wherein the bit number represents the lowest bit used in the encoding and the number of usable pixels decreases as the low order bits get used until merely none can be found, and wherein the maximum percentage value approximates the camera image coverage by the projector;

FIG. 6 is schematic diagram showing the projection of the center of Sₚ(s₀, t₀) approximated by averaging the pixel positions that were not rejected, i.e. from S_{c}(s₀, t₀), wherein the mapping of the center of Sₚ(s₀, t₀) onto the approximation of the center of S_{c}(s₀, t₀) is a sample of R⁻¹;

FIG. 7 is a method of finding the value R⁻¹(s*, t*) of an undefined point in the projector domain, by interpolating the values from the enclosing triangle using barycentric coordinates;

FIG. 8 illustrates an image reconstruction process wherein, when the projector displays the corrected image, the camera image contains a copy of the source image;

FIG. 9 is a top plan view of a multi-projector setup including a screen, a camera and two projectors and showing the respective positions of these screen, camera and projectors;

FIG. 10a is a side view of two planes of a screen angularly spaced apart by approximately 60°, for a single projector setup;

FIG. 10b shows that undistorted image for the projector results of distorted image in the camera image, for a single projector setup;

FIG. 10c is a corrected image wherein the curved line of brilliant pixels is a result of a different surface material, for a single projector setup;

FIG. 10d is a polar coordinates checkboard corrected pattern, for a single projector setup;

FIG. 10e is an enlarged view showing errors in the corrected image for a single projector setup, wherein black squares are area resulting of holes in the mapping and distortion are due to interpolation at borders with great discontinuity;

FIG. 11a is a side view of a screen showing a region covered by the projectors, for a multi-projector setup;

FIG. 11b is a checkboard without correction displayed by the first projector, for a multi-projector setup;

FIG. 11c is a checkboard without correction displayed by the second projector, for a multi-projector setup;

FIG. 11d is a corrected image projected by the first projector, for a multi-projector setup;

FIG. 11e is a corrected image projected by the second projector for a multi-projector setup, wherein errors in the right part of the image appear on a very inclined region of the dodecahedron with respect to the projector and wherein there is also a very large gap between the dodecahedron and the other screen surface;

FIG. 11f is a corrected image resulting from the combination of the images displayed by the two projectors of the multi-projector setup; and

FIG. 11g is another checkboard pattern corrected image resulting from the combination of the images displayed by the two projectors of the multi-projector setup.

### DETAILED DESCRIPTION OF THE ILLUSTRATIVE EMBODIMENT

The following non-restrictive description introduces an illustrative embodiment of the method and system according to the present invention allowing one or more projectors to display an undistorted image on a surface of unknown geometry. To achieve this, according to the illustrative embodiment:

a signal camera is used to capture the viewer's perspective of the projection surface;

no explicit camera and projector calibration is required since only their relative geometries are computed using structured light patterns;

there is no specific constraint on the position or the orientation of the projector(s) and the camera with respect to the projection surface, except that the area visible to the camera must be covered by the projector(s);

the calibration is represented as a function establishing the correspondence of each pixel of a projector image to a pixel of the camera image; and

after the mapping of each projector has been carried out, one can display an image corrected for the point of view of an observer, which takes into account the observer's position, the surface position, the projector position and orientation.

These method and system automatically take into account any distortion in the projector lenses. Typical applications of these method and system include projection in small rooms, shadow elimination and wide screen projection using multiple projectors. Intensity blending can be combined with this method and system to ensure minimal visual artefacts. The implementation has shown convincing results for many configurations.

More specifically, the illustrative embodiment of the method and system according to the present invention (hereinafter the illustrative embodiment) introduces an image correction scheme for projecting undistorted images from the point of view of the observer on any given surface. The illustrative embodiment of these method and system exploits structured light to generate a mapping between a projector and a camera. The following description then shows how the method and system can be used for a multi-projector system.

### Single Projector

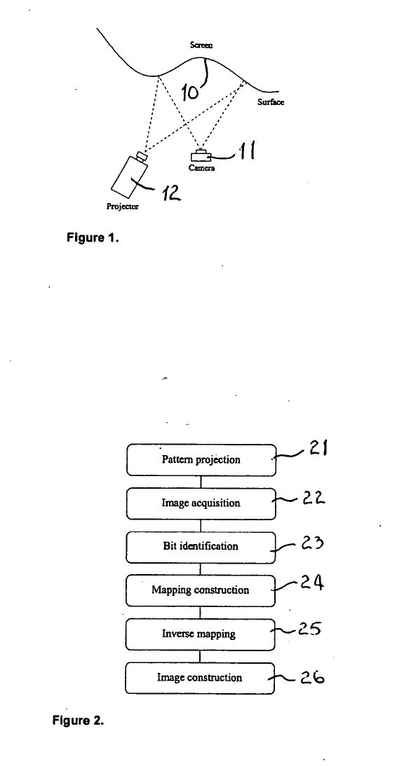

In order to project an image on a screen, some assumptions are made. In general, the screen is considered flat and the projector axis perpendicular to the flat screen. Thus, minimal distortions appear to an audience in front of the screen. Notice that the assumptions involve the relative position and orientation of the observer, the screen and the projector (see FIG. 1). Those constraints cannot be met when an arbitrary projection surface (screen) of unknown geometry such as 10 in FIG. 1 is used. In this case, information about the system including the screen 10, a camera 11, a projector 12, and the viewer (observer not shown in FIG. 1) has to be determined dynamically to correct the projected images to avoid distortion. The approach commonly used starts by finding a first function between the observer (not shown) and the screen 10 and a second function between the projector 11 and the screen 10. This involves calibration of the camera 11 and projector 12 described as:

$$( \begin{matrix}s \\ t \\ 1\end{matrix} ) ≅ {F}_{p} ( \begin{matrix}{x}_{w} \\ {y}_{w} \\ {z}_{w} \\ 1\end{matrix} ) ( \begin{matrix}u \\ v \\ 1\end{matrix} ) ≅ {F}_{c} ( \begin{matrix}{x}_{w} \\ {y}_{w} \\ {z}_{w} \\ 1\end{matrix} )$$

where ≅ implies equivalence up to a scale factor. The projective points (s, t, 1)^{T}, (u, v, 1)^{T} and (x_{w}, y_{w}, z_{w}, 1)^{T} are the projector image coordinates, camera image coordinates and surrounding world coordinates, respectively. 3D world points are related to projector image points by a 3×4 matrix Fₚ and are related to camera image points by a 3×4 matrix F_{c}. In the present method, the camera 11 models the observer's view point. The world coordinates are known from landmarks located on a calibration object. Then, the image coordinates are identified by getting the position of those landmarks in the camera image and the projector image. After that, Fₚ and F_{c} can be used to reconstruct the screen geometry using a combination of structured light and triangulation [6].

Another approach, limited to a flat projection surface, involves the use of homographies to model the transformations from image and projector planes to the screen. The main advantage of homographies is their representation by 3×3 invertible matrices defined as:

$$( \begin{matrix}s \\ t \\ 1\end{matrix} ) ≅ {H}_{p} ( \begin{matrix}{x}_{s} \\ {y}_{s} \\ 1\end{matrix} ) ( \begin{matrix}u \\ v \\ 1\end{matrix} ) ≅ {H}_{c} ( \begin{matrix}{x}_{s} \\ {y}_{s} \\ 1\end{matrix} )$$

where (xₛ, yₛ, 1)^{T} is an image point in the screen coordinates system, (s, t, 1)^{T} is an image point in the projector coordinates system, and (u, v, 1)^{T} is an image point in the camera coordinates system. From Hₚ and H_{c}, a relation between the coordinates system of the projector and the coordinates system of the camera can be established as:

$$( \begin{matrix}s \\ t \\ 1\end{matrix} ) ≅ {H}_{p} {H}_{c}^{- 1} ( \begin{matrix}u \\ v \\ 1\end{matrix} )$$

This mapping is invertible [14]. Homographies provide a linear mapping and are not directly useful when the screen is non-flat. Instead, the illustrative embodiment proposes to bypass the relation HₚH_{c}⁻¹ by a piecewise linear mapping function R relating the camera and the projector directly. If R is invertible, it is possible to compensate for an arbitrary observer-camera-projector setup.

The operations of the whole method conducted by the illustrative embodiment can be illustrated by the flow chart of FIG. 2, comprising a pattern projection 21, an image acquisition 22, a bit identification 23, a mapping construction 24, an inverse mapping 25, and an image reconstruction 26.

Operation 21: Pattern Projection

Structured light is commonly used in the field of 3D surface reconstruction. Using calibrated devices and a mapping between the camera 11 and the projector 12, reconstruction can be achieved quite easily [4]. However, the illustrative embodiment will show that even though the camera 11 and the projector 12 are not calibrated, a mapping between the camera 11 and the projector 12 is feasible as long as no full 3D reconstruction is needed.

For example, simple alternate black and white stripes can be used to build a correspondence from a point of the camera 11 to a coordinate in the projector 12 one bit at a time. For instance, for a n-bit coordinate encoding, each bit b (b ε{1, . . . , n}) is processed individually and yields an image of coded stripes, each of width 2^{b-1} pixels. The concatenation of all bits provides the complete coordinates.

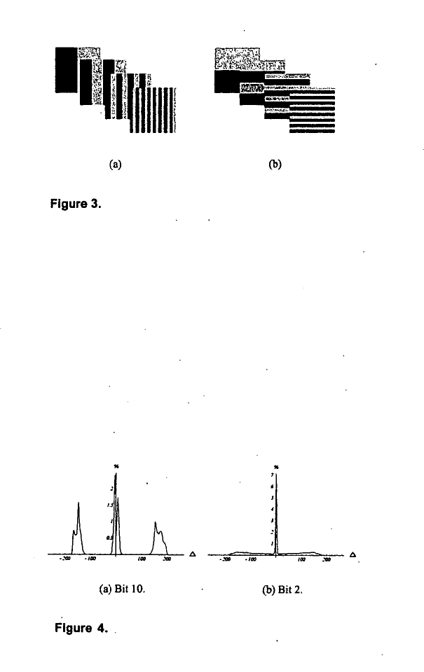

FIG. 3 gives an example of the coded projector images. Many coding schemes are possible. Some try to increase noise resistance (grey code), and some other try to reduce the number of patterns in order to speedup the scanning process (colors, sinus). In the illustrative embodiment of the method according to the present invention, the simplest possible pattern is used. As illustrated in FIG. 3, this simple pattern consists of two sets of horizontal and vertical stripes encoding s and t coordinates.

If a partial knowledge of the projector and camera relative position is available, then a single stripe orientation can be derived from the epipolar geometry. Assuming no such knowledge, two orientations to accommodate arbitrary geometries are used.

Operation 22: Image Acquisition

In order to compute a mapping function R from (u, v) to (s, t) this mapping function is first decomposed into partial mapping functions R_{b}^{s} and R_{b}^{t}, mapping the bit b of the s and t coordinates, respectively. These mapping functions are built by observing with the camera the projection of the corresponding stripe image and its inverse. Stripe identification is done with pixel-by-pixel difference between the image and its inverse, yielding Δ^{s} and Δ^{t} values between −255 and 255.

FIG. 4 gives examples of histograms of. Δ values. From these histograms, we find a rejection threshold τ that is going to be used to define which values are usable or rejected. Although several approaches could be used to select automatically the threshold τ, an empirical value of 50 is used. This is possible because the method is designed to tolerate rejected points. From this threshold, values are classified into three groups: 0, 1, and rejected (see Equation 1). This test preserves only the pixels for which we can tell with confidence that the intensity fluctuates significantly between the inverse images.

Point rejection occurs for two main reasons. First, a camera point might not be visible from the projector. Second, the contrast between the inverse stripes is too small. This occurs when the screen color is too dark or because of the limited resolution of the camera. In that case it causes two stripes of different colors to be projected onto the same camera pixel. This especially happens at borders between stripes. Thus, as the number of alternate stripes gets higher, the number of rejected pixels increases so much that we have observed that bit 1 and 2 (1 and 2 pixels stripes) are generally useless (see FIG. 4b).

Operation 23: Bit Identification

The bit mapping R_{b}^{s} can now be defined as:

$${R ( u , v )}_{b}^{s} = \{ \begin{matrix}0 & if {Δ}^{s} ( u , v ) < - τ \\ 1 & if {Δ}^{s} ( u , v ) > τ \\ rejected & otherwise\end{matrix} \qquad ( 1 )$$

where b is the bit number and Δ^{s} values are the inverse vertical stripes difference. Exactly the same process using horizontal stripes defines R(u, v)_{b}^{t} from Δ^{t} values. When a pixel is rejected, it will not be used anymore for the rest of the algorithm.

Operation 24: Mapping Construction

To obtain a complete mapping R from camera 11 to projector 12, the bit function R_{b}^{s} and R_{b}^{t} are concatenated to get:

$$R ( u , v ) = \{ \begin{matrix}\overbrace{{R ( u , v )}_{n}^{s} … {R ( u , v )}_{1}^{s}}^{s} , \overbrace{{R ( u , v )}_{n}^{t} … {R ( u , v )}_{1}^{t}}^{t} \\ if {R ( u , v )}_{b}^{s} ∈ \{ 0 , 1 \} ∀ b ∈ \{ 1 , … , n \} and \\ {R ( u , v )}_{b}^{t} ∈ \{ 0 , 1 \} ∀ b ∈ \{ 1 , … , n \} \\ rejected otherwise\end{matrix} . \qquad ( 2 )$$

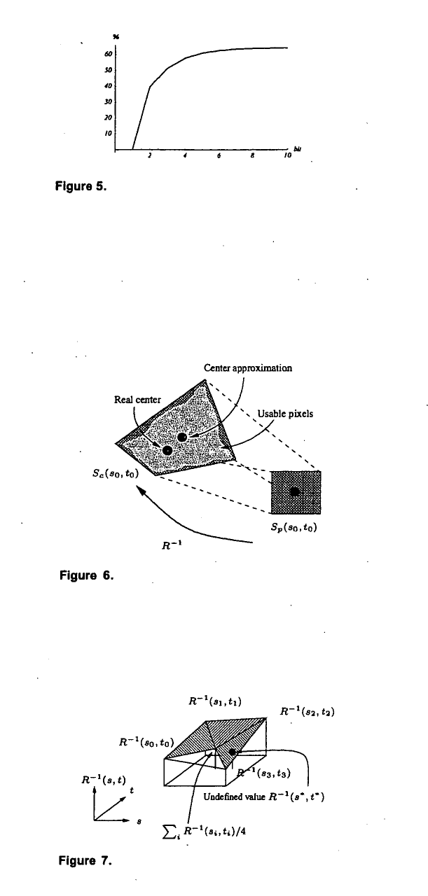

As mentioned before, acquiring partial functions R(u, v)_{b}^{s} and R(u, v)_{b}^{t} for low order bits b is generally impossible and Equation 2 rejects points for almost all (u, v) coordinates. Starting from the highest order bit, we observe in FIG. 5 that the percentage of usable pixels drops as lower order bits are used. Unfortunately, at some point, the percentage drops significantly (in FIG. 5: below bit three). Consequently, the illustrative embodiment uses a mapping on a number of bits n′ sufficiently small so that the number of usable points is not too small compared to the highest percentage. The n-n′ unused bits are set to 0 yielding a new mapping R′ defined as:

R′={Rₙ^{s} . . . R_{n-n′+1}^{s}0 . . . 0, Rₙ^{t} . . . R_{n-n′+1}^{t}0 . . . 0} (6)

The following section explains how to rebuild the function R⁻¹ from R′.

Operation 25: Inverse Mapping

For all pairs of coordinates (s₀, t₀) with bits from 1 to n-n′ set to zero, there is defined a set of camera pixels S_{c}(s₀,t₀)={(u, v)|R′(u, v)=(s₀,t₀)}. This is a contained region of the camera image as the thresholding eliminates possible outliers. We also define Sₚ(s₀,t₀)={(u,v)|(u,v)≡(u₀,v₀) mod 2^{n-n′}}, which is a 2^{n-n′}×2^{n-n′} square of pixels in the projector image. It is generally hard to establish the exact correspondence between points of S_{c}(s₀,t₀) and Sₚ(s₀,t₀). However one can estimate the projection center of Sₚ(s₀,t₀) by taking the average of the points of S_{c}(s₀,t₀) (see FIG. 6). Now, one can make the assumption that the latter is mapped through R onto the center Sₚ(s₀, t₀). Applying this process for all non-empty S_{c} for all (s₀,t₀) defines an under-sampling of the function R, and thus of R⁻¹ as well.

In order to complete the construction of R⁻¹, an interpolation scheme is used. The regular structure of the sampling makes it easy to implement because samples around a given point are easily found. If one of the samples needed for interpolation is undefined, interpolation also yields an undefined value. Whatever the value of n′ is, the reconstruction of R⁻¹ takes the same amount of time. For a 1024×768 image rebuilt with seven bits, this grid of points has dimensions 128×96, representing 12065 squares for the approximation of the function. Selecting the right interpolation scheme can be tricky. For instance, a straight bilinear interpolation has no simple geometrical interpretation. To achieve piecewise planar approximation of the surface, each rectangle were divided into four identical triangles. To find an undefined value R⁻¹(s*, t*) in the projector domain, the values from the vertices of the enclosing triangle are interpolated using barycentric coordinates (see FIG. 7).

Operation 26: Image Reconstruction

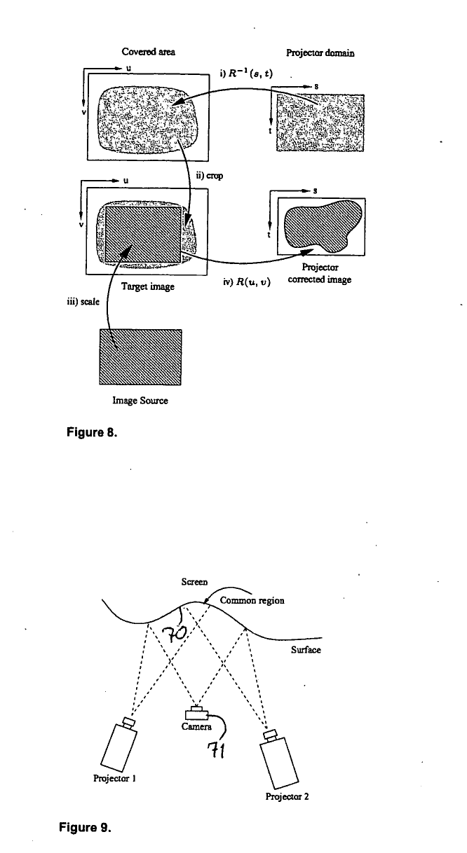

Once the inverse mapping function R⁻¹ is found, the construction of the projector image is easy. We need to build an image in the camera 11 which corresponds to what the observer should see: the target image. This is done in four steps: i) Identification of the portion of the camera image that is covered by the projector; ii) Cropping of that portion in order to get a rectangular image with the same ratio as the source image; iii) Scaling of the source image into this rectangle; all other pixels are set to black; iv) Determination of the color of each point (s, t) of the projector by looking at R⁻¹(s, t) in the target image. The process is summarized in FIG. 8.

### Multi-Projectors

Addition of more projectors to cover a larger screen 70 (FIG. 9) is rather simple. The method described above supports an arbitrary number of simultaneous projectors (Projector 1 and Projector 2 of FIG. 9). A scheme for intensity blending must however be developed for an arbitrary number of projectors. Ideally, every point of the projection surface visible by the camera 71 should be reached by at least one projector (Projector 1 and Projector 2 of FIG. 9). Clearly, in this case, less points of the camera image are used for each projector and the algorithm must be adjusted accordingly. In particular, the number of bits recovered for R could be smaller. To expect good results, a higher resolution camera 71 is required when each projector only covers a small part of the camera image. As an alternative, the number of used bits n′ can adjusted accordingly.

One function R⁻¹ is recovered for each projector, one at a time. To provide a corrected image without holes, the projector images must overlap, resulting in unwanted intensity fluctuations. These could be effectively corrected by intensity blending algorithms. Whatever the number of projectors is, it should be made sure that the camera 71 sees the entire screen 70.

### Experimental Setup

Even if the implementation does not depend on the projector or camera resolution, the quality of the results increases with the resolution of each device. In the experiments, a Sony Digital Handycam DCR-VX2000 (720×480 pixel resolution) and a Kodak DC-290 (1792×1200 pixel resolution) were used. In most cases, acquisition time is proportional to the resolution of the camera. Calibration time of each projector using the video camera was below two minutes and about 20 minutes for the Kodak digital camera. Two DLP projectors were used for the multi-projector setup: a Projectiondesign F1 SXGA and a Compaq iPAQ MP4800 XGA. Like every system using structured light, the optical characteristics of each device itself limit the possible screen shape that can be reconstructed. For instance, the depth of field of both camera and projector restricts the geometry and size of the screen. After the calibration process is carried out, the image correction can be done in less than a second, but can be easily done in real-time on current video hardware technology.

### Results

Single Projector Setup:

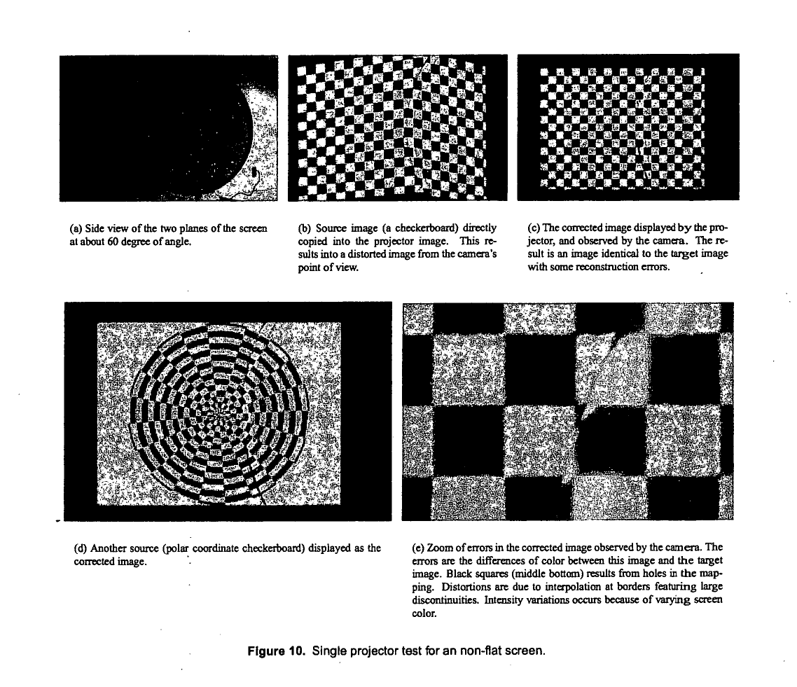

FIG. 10 illustrates how the image of one projector is corrected for a two-plane surface consisting of two circular screens. The camera and the projector were placed together so that the angles to each screen were about 50° and 70°. On the discontinuity between the two surfaces in the projector image, the distance along projection rays from one plane to the other was up to 15 centimetres (FIG. 10a). The Kodak camera was used so the R function could be constructed on eight bits out of 10. This allowed high precision corrected images (FIGS. 10c and 10d). Although errors are still present (FIG. 10e), this resulted in very high precision corrected images (FIGS. 10c and 10d).

Multiple Projector Setup:

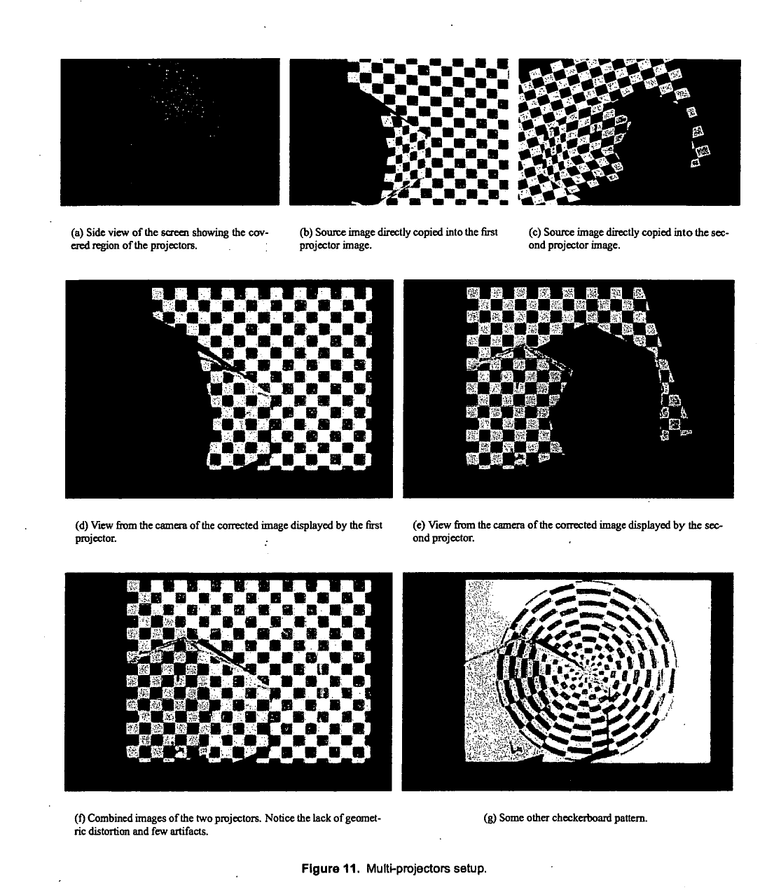

The second test demonstrates how a multi-projector setup can correct occlusions on a very peculiar surface geometry. Here, projection was done on a dodecahedron in front of a flat screen (FIG. 11a). Occlusions occur from both projectors, but very little from both simultaneously (FIGS. 11b-c). The Sony video camera was used and seven bits could be identified to compute R⁻¹ for both projectors. Results are shown in FIGS. 11d-g. Notice that even though the distortions and occlusions were large, the corrected images (FIGS. 11f,g) feature very few artefacts.

### Conclusion

The illustrative embodiment allows arbitrary observer-projector-screen geometries. Relying on a robust structured light approach, the method according to the illustrative embodiment is simple and accurate and can readily be adapted to multi-projector configurations that can automatically eliminate shadows.

Algorithmic determination of the rejection threshold r and of stripe width could automate the whole process. It would also make it possible to have these parameters adapt across different regions of the screen resulting in better reconstruction. Acquisition time could be decreased using improved patterns. Furthermore, hardware acceleration of video cards could be used to boost the speed of the construction of function R⁻¹ as well as the corrected image generation. This would allow real-time applications where slides or movies are projected over moving surfaces.

Although the present invention has been described in the foregoing specification by means of illustrative embodiments, these illustrative embodiments can be modified at will within the scope, spirit and nature of the subject invention. For example, the projector(s) could be replaced by video screens, for example LCD or plasma screens forming the surface on which the image has to be formed.

### References

[1] R. Azuma. A survey of augmented reality. In ACM SIGGRAPH, Course Notes #9: Developing Advanced virtual Reality Applications, pages 1-38, August 1995.

[2] Ramesh Raskar, Kok-Lim Low, and Greg Welch. Shader lamps: Animating real objects with image-based illumination. Technical Report TR00-027, 06 2000.

[3] R. Raskar, R. Ziegler, and T. Willwacher. Cartoon dioramas in motion. In International Symposium on Non-Photorealistic Animation and Rendering (NPAR), June 2002.

[4] Szymon Rusinkiewicz, Olaf Hall-Holt, and Marc Levoy. Real-time 3D model acquisition. In ACM Transactions on Graphics, volume 21, pages 438-446, 2002.

[5] Li Zhang, Brian Curless, and Steven M. Seitz. Rapid shape acquisition using color structured light and multi-pass dynamic programming. In 1st international symposium on 3D data processing, visualization, and transmission, Padova, Italy, June 2002.

[6] Ramesh Raskar, Michael S. Brown, Ruigang Yang, Wei-Chao Chen, Greg Welch, Herman Towles, Brent Seales, and Henry Fuchs. Multi-projector displays using camera-based registration. In IEEE visualization '99, pages 161-168, San Francisco, Calif., October 1999. IEEE. ISBN 0-7803-5897-X.

[7] Ramesh Raskar and Paul Beardsley. A self correcting projector. In IEEE Computer vision and Pattem Recognition (CvPR) 2001, Hawaii, December 2001.

[8] Ramesh Raskar. Immersive planar display using roughly aligned projectors. In IEEE VR, New Brunswick, N.J., USA, MARCH 2000.

[9] Ruigang Yang, D. Gotz, J. Hensley, H. Towles, and M. S. Brown. Pixelflex: a reconfigurable multi-projector display system. In IEEE Visualization 2001, pages 167-174, October 2001. ISBN 0-7803-7200-x.

[10] Rahul Sukhthankar. Calibrating scalable multi-projector displays using camera homography trees. In Computer vision and Pattern Recognition, 2001.

[11] R. Sukthankar, T. Cham, and G. Sukthankar. Dynamic shadow elimination for multi-projector displays. In CvPR, Projector IR Camera IR Light, 2001.

[12] C. Jaynes, S. Webb, R. M. Steele, M. Brown, and W. B. Seales. Dynamic shadow removal from front projection displays. In IEEE visualization 2001, pages 175-182, October 2001. ISBN 0-7803-7200-x.

[13] A. Majumder, Zhu He, H. Towles, and G. Welch. Achieving color uniformity across multi-projector displays. In IEEE Visualization 2000, pages 117-124, October 2000. ISBN 0-7803-6478-3.

[14] R. Hartley and A. Zisserman. Multiple View Geometry in Computer vision. Cambridge, 2000.

What is claimed is:

1. A method for displaying an undistorted, projector image on a surface of unknown geometry, comprising:
capturing an image of the surface from the point of view of an observer;
establishing a mapping between pixels of the captured image and pixels of the projector image;
displaying the target image on the surface, said display of the target image comprising correcting the target image in relation to the established mapping to display on the surface corresponding to the target image from the point of view of the observer.

2. A method of allowing at least one projector to display an undistorted, target image on a surface of unknown geometry, comprising:
capturing, by means of a camera, an image of the surface from the point of view of an observer;
establishing a mapping between pixels of the image from the camera and pixels of a projector image;
projecting the target image on the surface using the projector, said projection of the target image comprising correcting the target image in relation to the established mapping to display on the surface a target image undistorted from the point of view of the observer.

3. A method of allowing a projector to display an undistorted, target image on a surface of unknown geometry as defined in claim 2, wherein:
establishing a mapping comprises establishing a mapping between each pixel of the projector image and each pixel of the camera image.

4. A method of allowing a projector to display an undistorted, target image on a surface of unknown geometry as defined in claim 3, wherein:
establishing a mapping comprises establishing an inverse mapping from pixels of the projector image to pixels of the camera image; and
said method comprises constructing the projector image on the basis of the inverse mapping.

5. A method of allowing a projector to display an undistorted, target image on a surface of unknown geometry as defined in claim 2, wherein:
establishing a mapping comprises projecting, by means of said at least one projector, at least one pattern on the surface; said at least one pattern providing an encoding of the pixel position of the projector image.

6. A method of allowing a projector to display an undistorted, target image on a surface of unknown geometry as defined in claim 5, wherein:
the projected pattern comprises alternate black and white stripes.

7. A method of allowing a projector to display an undistorted, target image on a surface of unknown geometry as defined in claim 2, wherein:
a plurality of projectors are used in projecting the target image on the surface.

8. A system for allowing at least one projector to display an undistorted, target image on a surface of unknown geometry, comprising:
a camera for capturing an image of the surface from the point of view of an observer;
a producer of a mapping between pixels of the camera image and pixels of a projector image;
said at least one projector for projecting the target image on the surface using the projector, said system comprising a corrector of the target image projected by the at least one projector in relation to the established mapping to display on the surface a target image undistorted from the point of view of the observer.

9. A method of allowing a projector to display an undistorted, target image on a surface of unknown geometry as defined in claim 8, wherein the camera is a digital still camera or a digital video camera.

10. A method of allowing a projector to display an undistorted, target image on a surface of unknown geometry as defined in claim 8, wherein the projector is selected from the group consisting of a digital video projector, a laser point projector or a laser stripe projector.

11. A system for allowing a projector to display an undistorted, target image on a surface of unknown geometry as defined in claim 8, wherein:
the mapping producer establishes a mapping from each pixel of the projector image to a pixel of the camera image.

12. A system for allowing a projector to display an undistorted, target image on a surface of unknown geometry as defined in claim 11, wherein:
the mapping producer establishes an inverse mapping from pixels of the projector image to pixels of the camera image; and
said system comprises a producer of the projector image on the basis of the inverse mapping.

13. A system for allowing a projector to display an undistorted, target image on a surface of unknown geometry as defined in claim 8, wherein, when the camera captures an image of the surface, the at least one projector projects a pattern on the surface.

14. A system for allowing a projector to display an undistorted, target image on a surface of unknown geometry as defined in claim 13, wherein:
the projected pattern comprises alternate black and white stripes.

15. A system for allowing a projector to display an undistorted, target image on a surface of unknown geometry as defined in claim 8, comprising a plurality of projectors to project the target image on the surface.

16. A method of allowing a projector to display an undistorted, target image on a surface of unknown geometry as defined in claim 2, wherein at least one of said camera and said projector is uncalibrated with respect to the surface and the other of said projector and said camera.

17. A method for displaying an undistorted, target image on a surface of unknown geometry, comprising:
capturing an image of the surface from the point of view of an observer;
establishing a mapping between pixels of the captured image and pixels of the target image, taking into consideration respective positions of the observer and surface;
displaying the target image on the surface, said display of the -target image comprising correcting the target image in relation to the established mapping to display on the surface a target image undistorted from the point of view of the observer.
